(19) United States
(12) Patent Application Publication
(10) Pub. No.: US 2011/0005788 A1
(43) Pub. Date: Jan. 13, 2011

(54) TRANSMISSION MODULE FOR PNEUMATIC TOOL

(75) Inventor: HSIEN CHUNG CHEN, Taichung Hsien (TW)

Correspondence Address: PHILLIP LIU, 6980, WHITEOAK DRIVE, RICHMOND, BC, V7E 4Z9, CA

(73) Assignee: HYPHONE MACHINE INDUSTRY CO., LTD., Taichung Hsien (TW)

(21) Appl. No.: 12/794,738

(22) Filed: Jun. 5, 2010

(30) Foreign Application Priority Data
Jul. 10, 2009 (CN) 200920163976.5

(51) Int. Cl. B25D 9/06

(52) U.S. Cl. 173/94

(57) ABSTRACT

A transmission module includes a sleeve member, a cover disc, a hammering portion and an axle. The sleeve member has a rear disc and a cylinder body. A receiving space is defined between the rear disc and the cylinder body. The rear disc is formed with a teethed bore. The inner surface of the cylinder body is formed with at least one axially-stretched rib. The cover disc is disposed on the open end of the receiving space. The cover disc is formed with an axial bore. The hammering portion includes at least one rotary hammer, which is received in the receiving space. The rotary hammer has a through hole and a positioning groove. The rib is engaged with the positioning groove. The axle has a driven end and a working end. The driven end is inserted through the axial bore and mated with the through hole.

### BACKGROUND OF THE INVENTION

1. Field of the Invention

The present invention relates to a transmission module for a pneumatic tool.

2. Description of the Prior Art

Some conventional pneumatic tools are provided to tightly thread a screw in or out off a threaded bore. The pneumatic tool includes a transmission module, such as disclosed in TW M356577, to rotate the screw. The transmission module of TW M356577 is complicated and takes a considerable time for assembling.

The present invention is, therefore, arisen to obviate or at least mitigate the above mentioned disadvantages.

### SUMMARY OF THE INVENTION

The main object of the present invention is to provide a transmission module which is simplified and can be assembled quickly.

To achieve the above and other objects, a transmission module of the present invention includes a sleeve member, a cover disc, a hammering portion and an axle. The sleeve member has a rear disc and a cylinder body axially extended from the rear disc. A receiving space is defined between the rear disc and the cylinder body. The receiving space has an open. The rear disc is formed with a teethed bore. The cylinder body has an inner surface and an outer surface. The inner surface is formed with at least one axially-stretched rib. The cover disc is disposed on the open end of the receiving space. The cover disc is formed with an axial bore communicated with the receiving space. The hammering portion includes at least one rotary hammer, which is received in the receiving space. The rotary hammer has a through hole and a positioning groove. The rib is engaged with the positioning groove so that the hammering portion and the sleeve member are in a rotational operative relationship. The axle has a driven end and a working end. The driven end is inserted through the axial bore and mated with the through hole of the rotary hammer. The working end is protrusive from the cover disc.

The present invention will become more obvious from the following description when taken in connection with the accompanying drawings, which show, for purpose of illustrations only, the preferred embodiment(s) in accordance with the present invention.

BRIEF DESCRIPTION OF THE DRAWINGS

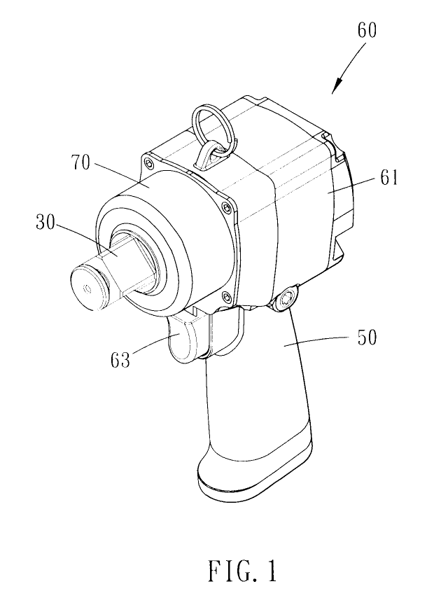

FIG. 1 is a perspective drawing showing a pneumatic tool having a transmission module of the present invention;

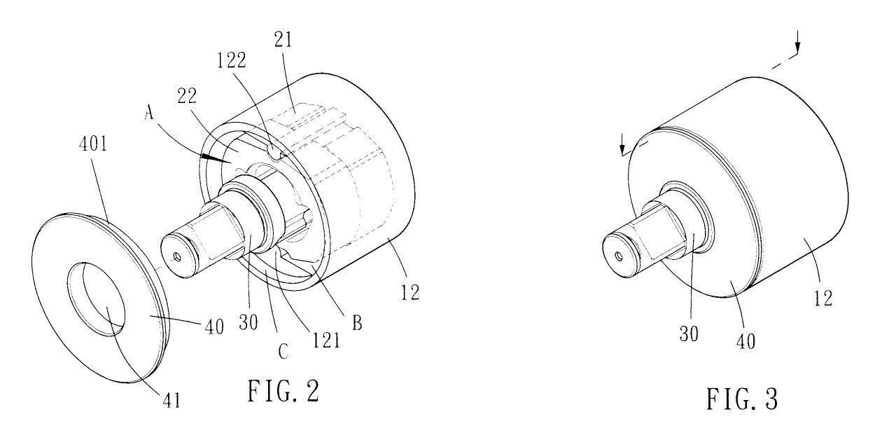

FIG. 2 is a partial breakdown drawing showing a transmission module of the present invention;

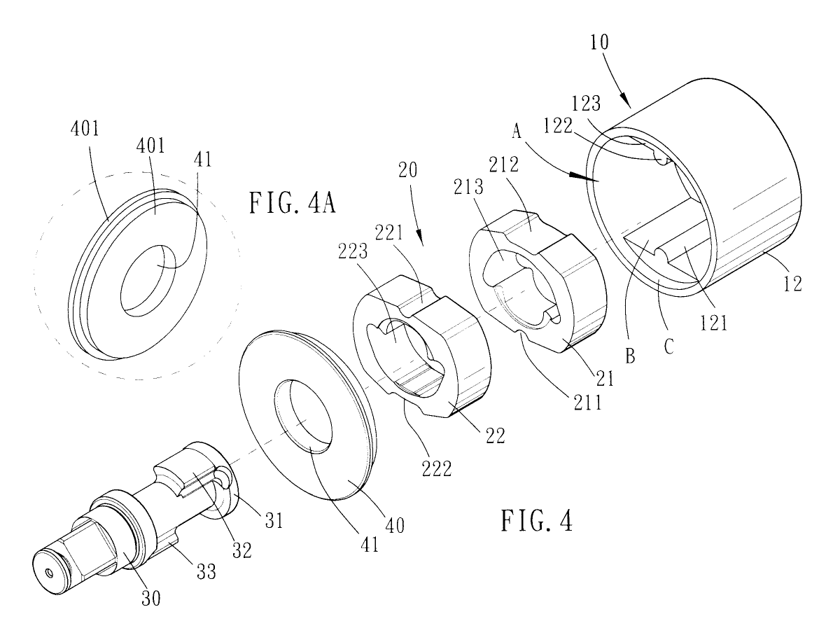

FIG. 3 is a perspective drawing showing a transmission module of the present invention;

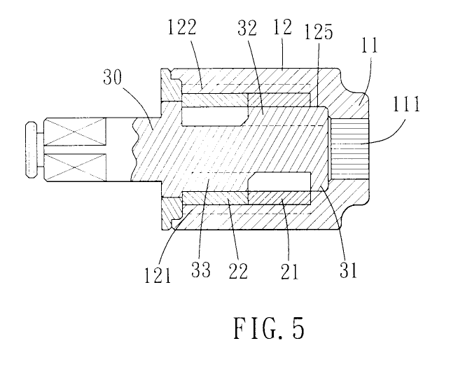

FIG. 4 is a breakdown drawing showing a transmission module of the present invention;

FIG. 4A is a perspective drawing showing a cover disc at another viewing angle;

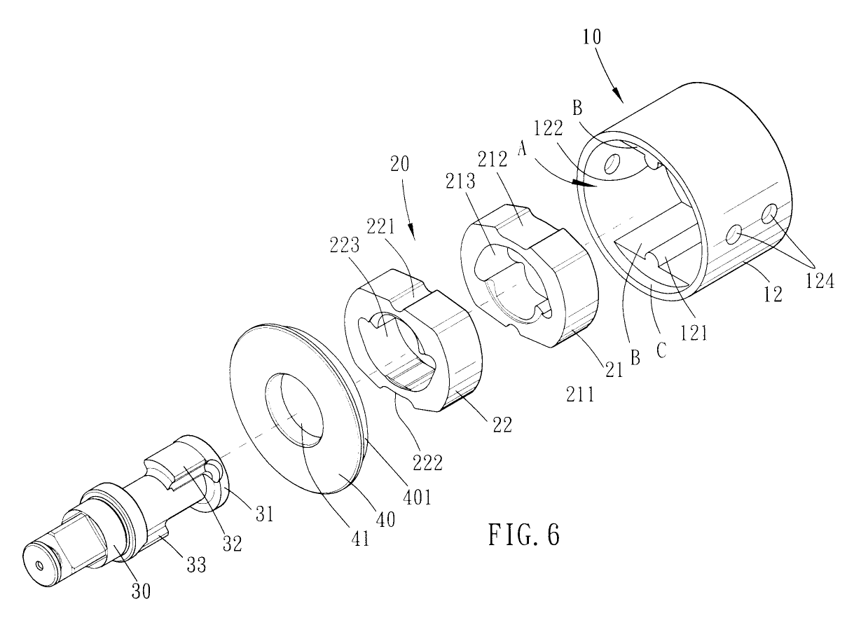

FIG. 5 is a profile showing a transmission module of the present invention;

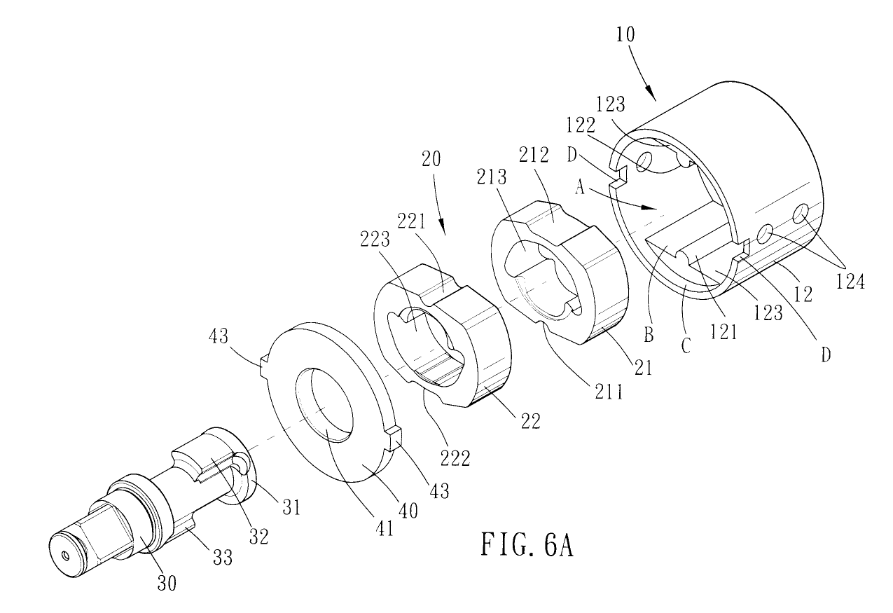

FIG. 6 is a breakdown drawing showing another transmission module of the present invention;

FIG. 6A is a breakdown drawing showing yet another transmission module of the present invention;

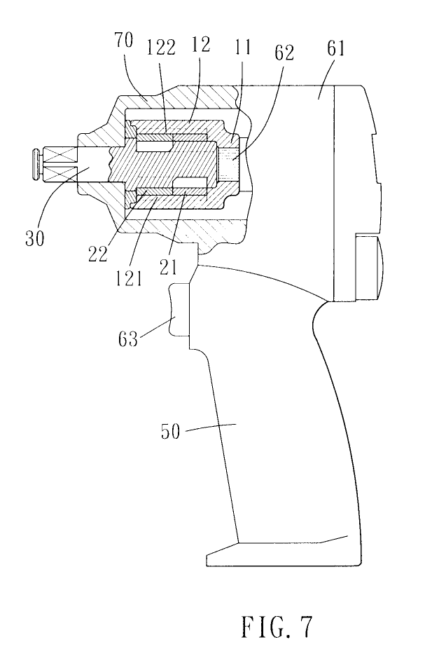

FIG. 7 is a partial profile showing a pneumatic tool having a transmission module of the present invention;

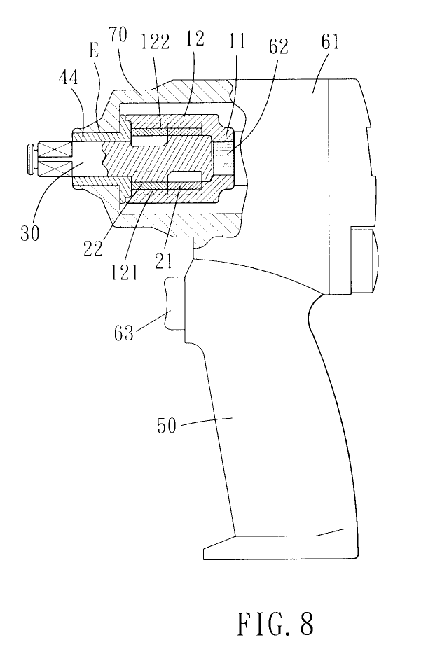

FIG. 8 is a partial profile showing a pneumatic tool having another transmission module of the present invention.

### DETAILED DESCRIPTION OF THE PREFERRED EMBODIMENTS

Please refer to FIG. 1. The transmission module of the present invention can be installed on a pneumatic tool. Please refer to FIG. 2 to FIG. 5. The transmission module includes a sleeve member 10, a hammering portion 20, an axle 30 and a cover disc 40. The sleeve member 10 has a rear disc 11 and a cylinder body 12. A receiving space A is defined between the rear disc 11 and the cylinder body 12, and the receiving space A has an open end. The rear disc 11 is formed with a teethed bore 111 for a teethed axle of a motor to engage therewith, so that the sleeve member 10 and the teethed axle of the motor are in a rotational operative relationship. The cylinder body 12 is axially extended form the rear disc 11 and has an inner surface and an outer surface. The inner surface of the cylinder body 12 is formed with two opposite plane stages B. A distance C is defined between the plane stages B and the open end of the receiving space A. The inner surface of the cylinder body 12 is further formed with two opposite axially-stretched ribs 121 and 122, which are protrusive from the stages B respectively and have semi-circular cross-section.

The hammering portion 20, as shown in FIG. 4 and FIG. 5, includes a first rotary hammer 21 and a second rotary hammer 22, both of which are received in the receiving space A. The rotary hammers 21 and 22 are identical in shape but are disposed mirror to each other. Specifically, the second rotary hammers 22 is up-side-down with respect to the first rotary hammer 21. And more specifically, the first rotary hammer 21 has a first positioning groove 211 corresponding to the rib 121 and a first sliding groove 212 corresponding to the rib 122. On the other hand, the second rotary hammer has a second sliding groove 222 corresponding to the rib 121 and a second positioning groove 221 corresponding to the rib 122. The positioning grooves 211 and 221 are engaged with the ribs 121 and 122 respectively. Each sliding groove 212, 222 is slightly wider that the rib 121, 122, so that the rotary hammers 21 and 22 are slightly swayable about the ribs 121 and 122 respectively. The rotary hammers 21 and 22 are axially formed with through holes 213 and 223 respectively. The axle 30 has a driven end and a working end. The driven end is axially inserted through the cover disc 40 and into the receiving space A to mate with the through holes 213 and 223. The working end is protrusive from the cover disc 40. A distal portion of the driven end is formed with a circular rim 31 which is surrounded with and supported by the inner surface of the cylinder body 12. Further, the cylinder body 12 may be formed with a supportive portion be support the circular rim 31. The driven end is formed with a first engaging shank 32 located in the first through hole 213 and a second engaging shank 32 located in the second through hole 223. The engaging shanks 32 and 33 are mated with the non-circular through holes 213 and 223 respectively, so that the axle 30 is rotatable when the hammering portion 20 is driven by the sleeve member 10. More specifically, the engaging shanks 32 and 33 can be selectively hammered by the protrusive portion of the non-circular through holes 213 and 223 respectively, so that the working end of the axle 30 can have sufficient power to drive a tightly fastened workpiece.

The cover disc 40 can be fixed to the sleeve member 10, either with the help of screws of not. Or, as shown in FIG. 6A, a diameter of the cover disc 40 equals to an inner diameter of the cylinder body 12, and the cover disc 40 is formed with two opposite arms 43 radially extended outward. The cylinder body 12 is formed with two opposite slots D to engage with the arms 43 respectively. As such, the receiving space A is enclosed by the cover disc 40.

Please refer to FIG. 4 and FIG. 4A. The cover disc 40 is formed with a stepped portion 401 axially extended toward the rear disc 11. A thickness of the stepped portion 401 equals to the distance C, so that the cover disc 40 can flush with the distal end of the cylinder body 12 when the stepped portion 401 is engaged in the receiving space A. The cover disc 40 is further formed with an axial bore 41 communicated with the receiving space A for the driven end of the axle 30 to insert therethrough. Further, the axial bore 41 can be also used to support the axle 30, so that the axle 30 can steadily rotate about its axis.

Please refer to FIG. 8. The cover disc 40 can be further formed with an annular wall 44 axially extended outward. The annular wall 44 surrounds the axial bore 41, so that the annular wall 44 can be supported by the inner wall E of the pneumatic tool, so as to further support the axle 30. As such, the axle 30 can rotate even more steadily.

Please refer to FIG. 1 and FIG. 7. The transmission module of the present invention can be installed on a pneumatic tool, which includes a handle portion 50, a power portion 60 and a sleeve portion 70. The power portion 60 is disposed one end of the handle portion 50 and includes a power device 61, a teethed axle 62 and a switching button 63 to turn the power device on or off. The power device 61 can drive the teethed axle 62 to rotate, while the teethed axle 62 is engaged with the sleeve member 10. The sleeve portion 70 is installed in front of the power device 61 and defines a hole for the axle 30 to extend outward therefrom.

Please refer to FIG. 6. The cylinder body 12 can be formed with some bores 124, which is perpendicular or slanted to the axis of the sleeve member 10. Preferably, each bore 124 is stepped and has a wide portion and a narrow portion, in which the wide portion is adjacent to the outer surface of the cylinder body, and the narrow portion is adjacent to the inner wall of the cylinder body. As such, lubricant can be filled in the receiving space through the bores 124, and the stepped design of the bores can help prevent the lubricant from leaking out of the receiving space.

What is claimed is:

1. A transmission module for a pneumatic tool, comprising:
a sleeve member, having a rear disc and a cylinder body axially extended from the rear disc, a receiving space being defined between the rear disc and the cylinder body, the receiving space having an open end, the rear disc being formed with a teethed bore, the cylinder body having an inner surface and an outer surface, the inner surface is formed with at least one axially-stretched rib;
a cover disc, disposed on the open end of the receiving space, the cover disc is formed with an axial bore communicated with the receiving space;
a hammering portion, comprising at least one rotary hammer, the rotary hammer being received in the receiving space, the rotary hammer having a through hole and a positioning groove, the rib being engaged with the positioning groove so that the hammering portion and the sleeve member being in a rotational operative relationship; and
an axle, having a driven end and a working end, the driven end being inserted through the axial bore and mated with the through hole of the rotary hammer, the working end being protrusive from the cover disc.

2. The transmission module of claim 1, wherein the inner surface of the cylinder body is formed with two opposite plane stages and two opposite axially-stretched ribs, the ribs are radially inward protrusive from the plane stages respectively, the hammering portion comprises two rotary hammers, each of which has a positioning groove to engage with one of the ribs, each rotary hammer has a non-circular through hole, the driven end is formed with two engaging shanks to mate with the non-circular through holes of the rotary hammers respectively.

3. The transmission module of claim 2, a distance is defined between the plane stages and the open end of the receiving space, the cover disc is formed with a stepped portion extended toward the rear disc, a thickness of the stepped portion equals to the distance.

4. The transmission module of claim 1, wherein the cylinder body is formed with at least one bore communicated with the receiving space.

5. The transmission module of claim 4, wherein the at least one bore is slanted formed on the cylinder body.

6. The transmission module of claim 4, wherein the bore is stepped and has a wide portion and a narrow portion, the wide portion is adjacent to the outer surface of the cylinder body, the narrow portion is adjacent to the inner surface of the cylinder body.

7. The transmission module of claim 1, wherein the cover disc is formed with an annular wall axially extended outward, the annular wall surrounds the axial bore.

8. The transmission module of claim 1, wherein a diameter of the cover disc equals to an inner diameter of the cylinder body, the cover disc is formed with two opposite arms radially extended outward, the cylinder body is formed with two opposite slots to engage with the arms respectively.
